(19) United States
(12) Patent Application Publication
(10) Pub. No.: US 2015/0103012 A1
(43) Pub. Date: Apr. 16, 2015

(54) KEYBOARD

(71) Applicants: HON HAI PRECISION INDUSTRY CO., LTD., NEW TAIPEI (TW); HONG FU JIN PRECISION INDUSTRY (SHENZHEN) CO., LTD., SHENZHEN (CN)

(72) Inventors: GUI-FU XIAO, Shenzhen (CN); CHENG-FEI WENG, Shenzhen (CN)

(73) Assignees: HON HAI PRECISION INDUSTRY CO., LTD., NEW TAIPEI (TW); HONG FU JIN PRECISION INDUSTRY (SHENZHEN) CO., LTD., SHENZHEN (CN)

(21) Appl. No.: 14/178,160

(22) Filed: Feb. 11, 2014

(30) Foreign Application Priority Data
Oct. 15, 2013 (CN) 2013105096839

(51) Int. Cl. G06F 3/02

(52) U.S. Cl. CPC G06F 3/0227
USPC 345/168

(57) ABSTRACT

A keyboard includes a housing, a number of keys, a circuit board received in the housing, and a connecting port. The circuit board includes a main control unit, a key control unit, and an analyzing unit. The connecting port is configured for electrically connecting the circuit board to a main board of a computer. The main control unit includes a main controller. The key control unit includes a key controlling module electrically connected to the keys, and a processor electrically connected to the key controlling module through the main controller. The analyzing unit includes a display and an analyzing module. The analyzing module is electrically connected to the main controller and the connecting port, and is capable of reading breakdown information of the main board of the computer under the control of the main controller. The analyzing module displays the breakdown information on the display.

### BACKGROUND

1. Technical Field

The present disclosure relates to a keyboard.

2. Description of Related Art

A computer may break down in operation. Thus, a user needs to determine the cause of the breakdown. However, it is often inconvenient to determine the cause of the breakdown.

Therefore, it is desirable to provide a means that can overcome the shortcoming mentioned above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, isometric view of an embodiment of a keyboard.

FIG. 2 is a cross-sectional view taken along line II-II of FIG. 1.

FIG. 3 is a functional block diagram of a circuit board of the keyboard of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

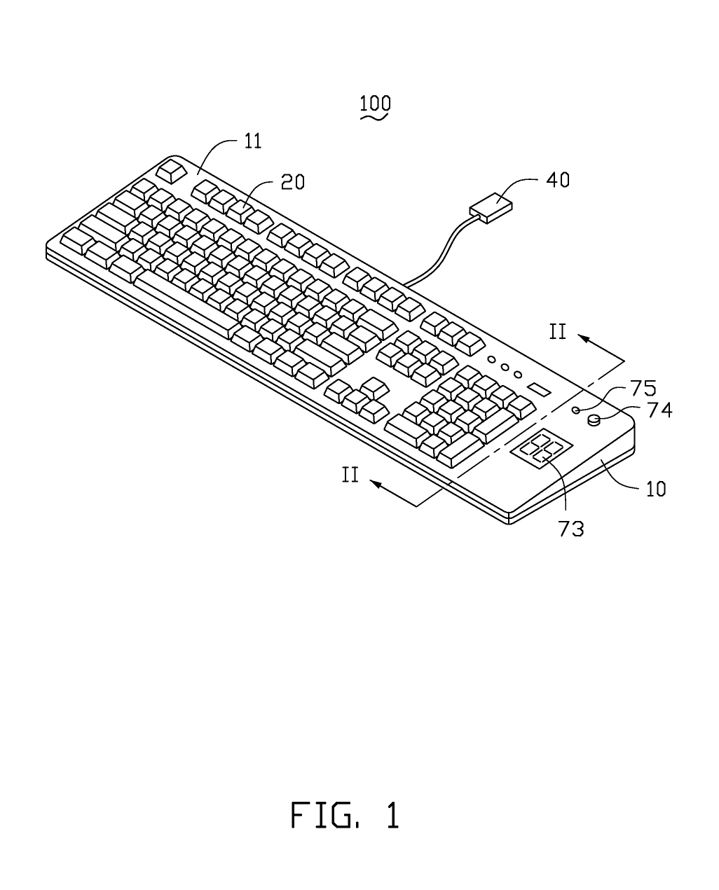

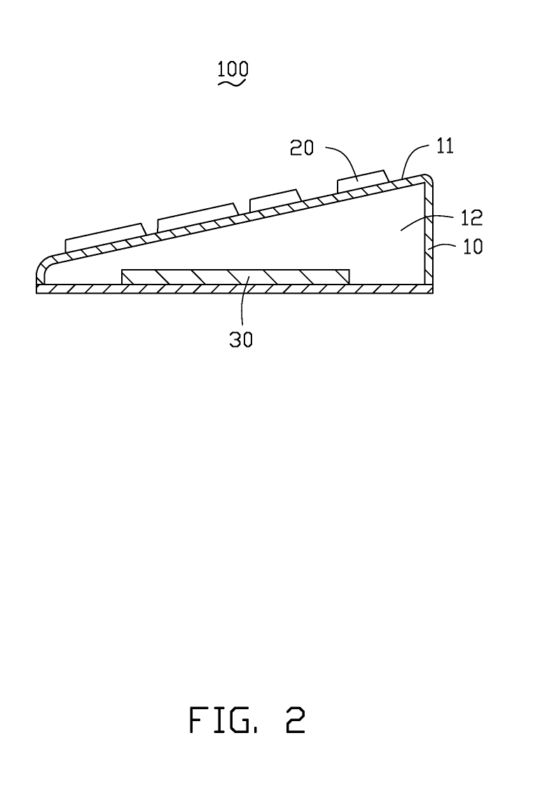

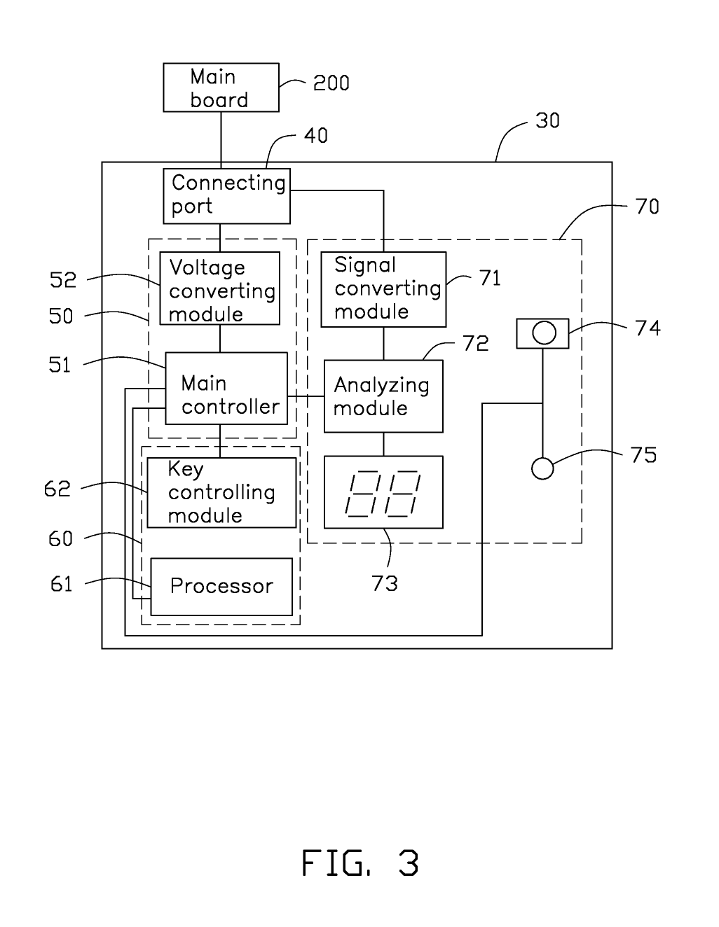

FIGS. 1 through 3 show an embodiment of a keyboard 100. The keyboard 100 includes a housing 10, a plurality of keys 20, a circuit board 30, and a connecting port 40. The circuit board 30 includes a main control unit 50, a key control unit 60, and an analyzing unit 70.

The housing 10 includes an operating surface 11. The keys 20 are located on the operating surface 11.

The housing 10 defines a receiving space 12 for receiving the circuit board 30.

The connecting port 40 is configured for electrically connecting the circuit board 30 to a main board 200 of a computer. In this embodiment, the connecting port 40 is a universal serial bus (USB) port.

The main control unit 50 includes a main controller 51 and a voltage converting module 52. The voltage converting module 52 is electrically connected to the main controller 51 and the connecting port 40, and configured for converting an output voltage of the connecting port 40 into a working voltage of the main controller 51. In this embodiment, the main controller 51 is a complex programmable logic device (CPLD), the output voltage of the connecting port 40 is about 5 volts (V), and the working voltage of the main controller 51 is about 3.3 V.

The key control unit 60 includes a processor 61 and a key controlling module 62. The processor 61 is electrically connected to the key controlling module 62 through the main controller 51, and the key controlling module is electrically connected to the keys 20. Because the CPLD has an excess number of input/output (I/O) pins (not shown), if more keys 20 are needed, idle I/O pins can be used to electrically connect to and form new keys 20. The processor 61 does not need to control the keys 20 directly and only needs to control the CPLD, thus, a processing ability of the processor 61 can be reduced.

The analyzing unit 70 includes a signal converting module 71, an analyzing module 72, a display 73, a trigger key 74, and an indicating lamp 75.

The signal converting module 71 is electrically connected to the analyzing module 72 and the connecting port 40, and configured for converting an I/O signal of the main board 200 (a USB signal) into a distinguishable signal of the analyzing module 72. In one embodiment, the distinguishable signal is a low pin count (LPC) signal.

The analyzing module 72 is electrically connected to the main controller 51 and reads breakdown information of the main board 200. The analyzing module 72 displays the breakdown information on the display 73 under the control of the main controller 51. In the illustrated embodiment, the display 73 is a two-piece seven-segment display. For example, the display 73 displays a number, which represents corresponding breakdown information of the main board 200.

The trigger key 74 and the indicating lamp 75 are located on the operating surface 11.

The trigger key 74 and the indicating lamp 75 are electrically connected to the main controller 51. The main controller 51 controls a working state of the analyzing module 72 and of the key control unit 60 according to an input of the trigger key 74. The indicating lamp 75 indicates the working state of the analyzing module 72 and of the key control unit 60. In detail, when the trigger key 74 is pressed a first time, the main controller 51 controls the analyzing module 72 and the key control unit 60 to stop working, which causes the indicating lamp 75 to light up. When the trigger key 74 is pressed a second time, the main controller 51 controls the analyzing module 72 and the key control unit 60 to start working again, which causes the indicating lamp 74 to turn off.

Because the keyboard 100 includes the analyzing unit 70, which can read and display breakdown information of the main board 200, a user can easily see what kind of breakdown occurs in the main board 200 and quickly resolve the breakdown.

It will be understood that the above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. A keyboard comprising:
a housing comprising an operating surface;
a plurality of keys arranged on the operating surface;
a circuit board received in the housing; and
a connecting port, a main control unit, a key control unit, and an analyzing unit respectively mounted on and electrically connected to the circuit board; wherein the connecting port is configured for electrically connecting the circuit board to a main board of a computer, the main control unit comprises a main controller, the key control unit comprises a key controlling module electrically connected to the keys and a processor electrically connected to the key controlling module through the main controller, the analyzing unit comprises a display and an analyzing module, the analyzing module is electrically connected to the main controller and the connecting port, and is capable of reading a breakdown information of the main board of the computer under the control of the main controller, and displaying the breakdown information on the display.

2. The keyboard of claim 1, wherein the main controller is a complex programmable logic device (CPLD).

3. The keyboard of claim 1, wherein the analyzing unit further comprises a signal converting module electrically connected between the analyzing module and the connecting port, and configured for converting an input/output (I/O) signal of the connecting port into a signal capable of being distinguished by the analyzing module.

4. The keyboard of claim 3, wherein the connecting port is a universal serial bus (USB) port.

5. The keyboard of claim 1, wherein the main control unit further comprises a voltage converting module for converting an output voltage of the connecting port to a working voltage of the main controller.

6. The keyboard of claim 5, wherein the output voltage of the connecting port is 5 voltages, and the working voltages of the main controller is 3.3 voltages.

7. The keyboard of claim 1, wherein the analyzing unit further comprises a trigger key electrically connected to eth main controller, the main controller controls a working state of the analyzing module and the key control unit according to an input information from the trigger key.

8. The keyboard of claim 7, wherein the analyzing unit further comprises an indicating lamp for indicating the input information from the trigger key.

9. The keyboard of claim 8, wherein when the trigger key is pressed for a first time, the main controller controls the analyzing module and the key control unit stop working and the indicating lamp is lighted, when the trigger key is pressed for a second time, the main controller controls the analyzing module and the key control unit start working and the indicating lamp is turned off.

10. The keyboard of claim 8, wherein the trigger key and the indicating lamp are mounted on the operating surface.
